(19) United States
(12) Patent Application Publication
(10) Pub. No.: US 2020/0192240 A1
(43) Pub. Date: Jun. 18, 2020

(54) DEVELOPING DEVICE AND IMAGE FORMING APPARATUS

(71) Applicant: Konica Minolta, Inc., Tokyo (JP)

(72) Inventors: Shota SAKURAI, Tokyo (JP); Hiroyuki SAITO, Tokyo (JP); Yuji KAMODA, Osaka (JP); Tatsuya FURUTA, Tokyo (JP)

(21) Appl. No.: 16/703,678

(22) Filed: Dec. 4, 2019

(30) Foreign Application Priority Data
Dec. 14, 2018 (JP) 2018-234086

(51) Int. Cl. G03G 15/08; G03G 15/00

(52) U.S. Cl. CPC G03G 15/0856; G03G 15/0889; G03G 15/556; G03G 15/0868; G03G 15/0891

(57) ABSTRACT

A developing device includes a developer casing, a developer detector, and a hardware processor that performs control to set a developer amount range to either a first detection condition or a second detection condition. The hardware processor determines whether or not a developer amount within the developer casing has exceeded an acceptable value, based on a detection result in the developer detector under the second detection condition.

### CROSS REFERENCE TO RELATED APPLICATIONS

The entire disclosure of Japanese patent Application No. 2018-234086, filed on Dec. 14, 2018, is incorporated herein by reference in its entirety.

### BACKGROUND

### Technological Field

The present invention relates to a developing device and an image forming apparatus.

### Description of Related Art

A developing device provided in an image forming apparatus includes a developer detecting section that can detect developer within the developing device. The developer detecting section is used to detect the developer within the developing device, and an amount of the developer within the developing device is controlled depending on a result of the detection.

Since such a developer detecting section, however, has a detection range that is limited to a predetermined height range, a liquid level of the developer out of the detection range causes a problem of deteriorated detection precision for the developer amount. In particular, when the developer amount increases with a larger developing device, the above described problem becomes significant.

For example, Japanese Patent Application Laid-Open No. 2009-58939 discloses a configuration with two detecting sections at both an upper limit side and a lower limit side of the developer amount. The two detecting sections provided in this configuration can inhibit the deterioration of the detection precision for the developer amount, so that the developer amount within the developing device can be appropriately controlled.

### SUMMARY

The configuration described in Japanese Patent Application Laid-Open No. 2009-58939, however, involves costs for providing the two detecting sections. Moreover, an individual difference in sensitivity of each detecting section is likely to cause variation in the detection precision for the developer amount. The configuration described in Japanese Patent Application Laid-Open No. 2009-58939 thus has certain limitations as a configuration of appropriately controlling the developer amount.

An object of the present invention is to provide a developing device and an image forming apparatus that can appropriately control the developer amount and thus realize stabilization of the developer amount.

To achieve at least one of the abovementioned objects, according to an aspect of the present invention, a developing device reflecting one aspect of the present invention comprises:

a developer casing that accommodates developer to be supplied to a developer bearing member;

a developer detector that detects a liquid level of the developer within the developer casing; and

a hardware processor that performs control to set a developer amount range based on a detection result in the developer detector to either a first detection condition where the developer amount range is a first range that is a range during a developing operation, or a second detection condition where the developer amount range is a second range that is different from the first range,

wherein the hardware processor determines whether or not a developer amount within the developer casing has exceeded an acceptable value, based on the detection result in the developer detector under the second detection condition.

To achieve at least one of the abovementioned objects, according to an aspect of the present invention, an image forming apparatus reflecting one aspect of the present invention comprises:

a developer casing that accommodates developer to be supplied to a developer bearing member;

a developer detector that detects a liquid level of the developer within the developer casing; and

a hardware processor that performs control to set a developer amount range based on a detection result in the developer detector to either a first detection condition where the developer amount range is a first range that is a range during a developing operation, or a second detection condition where the developer amount range is a second range that is different from the first range,

wherein the hardware processor determines whether or not a developer amount within the developer casing has exceeded an acceptable value, based on the detection result in the developer detector under the second detection condition.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 schematically illustrates an overall configuration of an image forming apparatus according to an embodiment of the present invention;

FIG. 2 illustrates a main part of a control system of the image forming apparatus according to the present embodiment;

FIG. 3A is a sectional side view of a developing device;

FIG. 3B is a sectional view of the developing device as seen from above;

FIG. 4A illustrates liquid levels near a developer detecting section under a first detection condition;

FIG. 4B illustrates a relationship between output of the developer detecting section and the liquid level of developer;

FIG. 5 illustrates the liquid levels near the developer detecting section when an amount of the developer has increased under the first detection condition;

FIG. 6A illustrates the liquid levels near the developer detecting section under a second detection condition;

FIG. 6B illustrates a relationship between the output of the developer detecting section and the developer amount under each detection condition;

FIG. 7 illustrates changes in a detection result at the developer detecting section with respect to a number of passing sheets;

FIG. 8 is a flowchart illustrating an example of an operation example when developer amount adjustment control is executed in the image forming apparatus;

FIG. 9A is a sectional view of the developing device according to a first variation, as seen from above;

FIG. 9B is a sectional view of the developing device according to the first variation, as seen from above;

FIG. 10A is a sectional view of the developing device according to a second variation, as seen from above;

FIG. 10B is a sectional view of the developing device according to the second variation, as seen from above; and

FIG. 11 is a sectional view of the developing device according to a third variation, as seen from above.

### DETAILED DESCRIPTION OF EMBODIMENTS

Hereinafter, one or more embodiments of the present invention will be described with reference to the drawings. However, the scope of the invention is not limited to the disclosed embodiments.

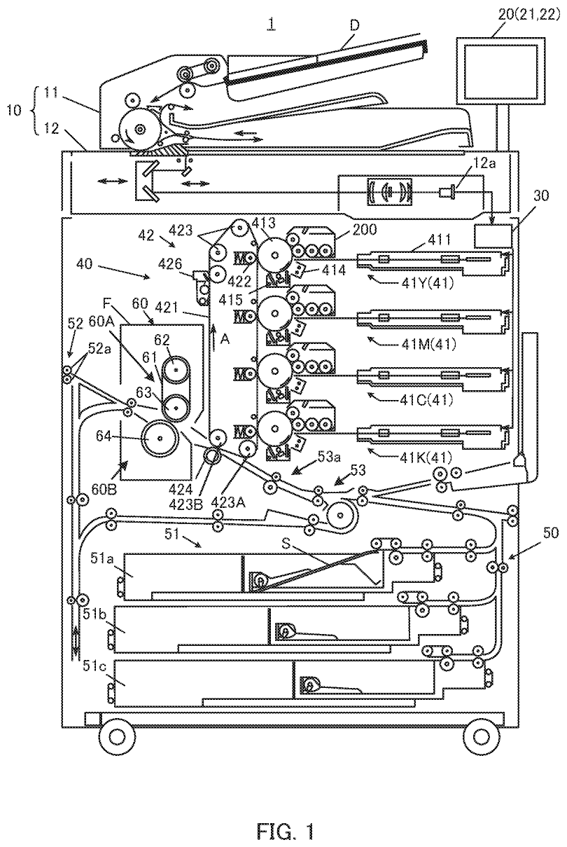

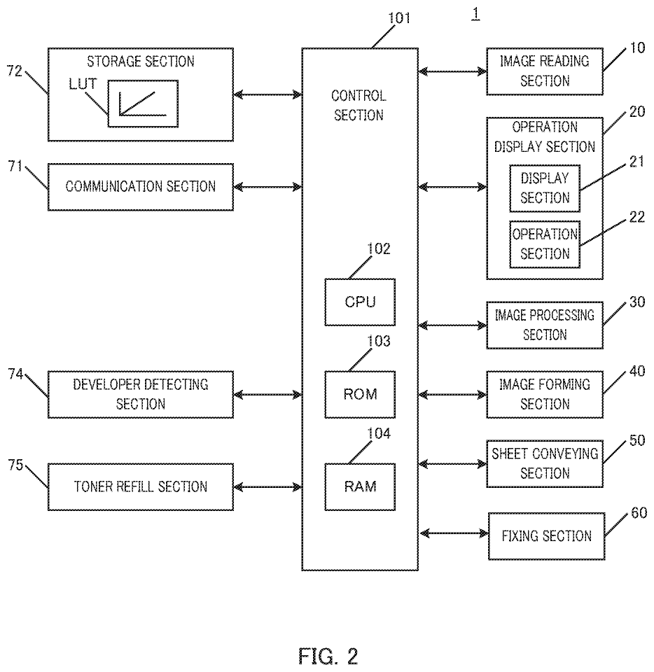

An embodiment of the present invention will be described in detail below based on the accompanying drawings. FIG. 1 schematically illustrates an overall configuration of image forming apparatus 1 according to the embodiment of the present invention. FIG. 2 illustrates a main part of a control system of image forming apparatus 1 according to the present embodiment.

As illustrated in FIG. 1, image forming apparatus 1 is a color image forming apparatus of an intermediate transfer system (type) utilizing an electrophotographic process technology. In other words, image forming apparatus 1 primarily transfers toner images of respective colors of Y (yellow), M (magenta), C (cyan), and K (black) formed on photoconductor drums 413, onto intermediate transfer belt 421, superimposes the toner images of the four colors on intermediate transfer belt 421, then secondarily transfers the toner images onto a sheet S delivered from sheet feed tray units 51a to 51c, and thereby forms an image.

Image forming apparatus 1 also employs a tandem system including photoconductor drums 413 corresponding to the four colors of YMCK disposed serially in a running direction of intermediate transfer belt 421, so that the toner images of the respective colors are sequentially transferred onto intermediate transfer belt 421 in a single procedure.

As illustrated in FIG. 2, image forming apparatus 1 includes image reading section 10, operation display section 20, image processing section 30, image forming section 40, sheet conveying section 50, fixing section 60, and control section 101.

Control section 101 includes Central Processing Unit (CPU) 102, Read Only Memory (ROM) 103, Random Access Memory (RAM) 104, and the like. CPU 102 reads out programs depending on processing content from ROM 103, expands the programs into RAM 104, and centrally controls operations of each block and the like of image forming apparatus 1, in cooperation with the expanded programs. Then, various data stored in storage section 72 is referred. Storage section 72, for example, is composed of a non-volatile semiconductor memory (so-called flash memory) or a hard disk drive.

Control section 101 transmits and receives the various data to and from an external apparatus (for example, a personal computer) connected to a communication network, such as a Local Area Network (LAN) or a Wide Area Network (WAN), via communication section 71. Control section 101, for example, receives image data (input image data) transmitted from the external apparatus, and forms an image on the sheet S based on this image data. Communication section 71, for example, is composed of a communication control card such as a LAN card.

As illustrated in FIG. 1, image reading section 10 is configured with automatic original document sheet feeding apparatus 11 referred to as Auto Document Feeder (ADF), original image scanning apparatus 12 (scanner), and the like.

Automatic original document sheet feeding apparatus 11 conveys an original document D placed on an original document tray through a conveyance mechanism, and sends the original document D out to original image scanning apparatus 12. Automatic original document sheet feeding apparatus 11 enables images (including both sides) of a large number of original documents D placed on the original document tray to be successively read at once.

Original image scanning apparatus 12 optically scans the original document conveyed onto contact glass from automatic original document sheet feeding apparatus 11, or the original document placed on the contact glass, images reflected light from the original document onto a light receiving surface of Charge Coupled Device (CCD) sensor 12a, and thereby reads the original image. Image reading section 10 generates input image data based on a result of reading by original image scanning apparatus 12. This input image data is subjected to predetermined image processing in image processing section 30.

As illustrated in FIG. 2, operation display section 20, for example, is composed of a liquid crystal display (LCD) with a touch panel, and functions as display section 21 and operation section 22. Display section 21 displays various operation screens, image states, an operation status of each function, and the like, according to a display control signal inputted from control section 101. Operation section 22 includes various operation keys, such as a numeric key pad and a start key, accepts various input operations by a user, and outputs an operation signal to control section 101.

Image processing section 30 includes a circuit and the like that performs digital image processing on the input image data depending on initial setting or user setting. Image processing section 30, for example, performs tone correction based on tone correction data (tone correction table) under the control of control section 101. In addition to the tone correction, image processing section 30 also applies various correction processes such as color correction and shading correction, a compression process, and the like, to the input image data. Image forming section 40 is controlled based on image data subjected to these processes.

As illustrated in FIG. 1, image forming section 40 includes image forming units 41Y, 41M, 41C and 41K that form images of respective colored toners of a Y component, an M component, a C component and a K component based on the input image data, intermediate transfer unit 42, and the like.

Image forming units 41Y, 41M, 41C and 41K for the Y component, the M component, the C component and the K component have similar configurations. For convenience of illustration and explanation, common components are denoted by the same reference numerals, and Y, M, C or K is added to the reference numerals when the components are distinguished. In FIG. 1, only the components of image forming unit 41Y for the Y component are denoted by reference numerals, and reference numerals of the components of the other image forming units 41M, 41C and 41K are omitted.

Image forming unit 41 includes exposing device 411, developing device 200, photoconductor drum 413, charging device 414, and drum cleaning apparatus 415.

Photoconductor drum 413, for example, is composed of an organic photoconductor, which has a photosensitive layer that is made of a resin containing an organic photoconductive body and is formed on an outer peripheral surface of a drum-like metallic substrate.

Control section 101 controls drive current to be supplied to a drive motor (illustration is omitted) that rotates photoconductor drum 413, and thereby rotates photoconductor drum 413 at a certain peripheral speed.

Charging device 414, for example, is an electrification charger, and generates corona discharging, thereby uniformly and negatively electrifying a surface of photoconductor drum 413 having photoconductivity.

Exposing device 411, for example, is composed of a semiconductor laser, and emits laser light corresponding to an image of each color component, to photoconductor drum 413. As a result, an electrostatic latent image of each color component is formed in an image region to which the laser light has been emitted, on the surface of photoconductor drum 413, due to a potential difference with a background region.

Developing device 200 is a two-component reversal type developing device, and visualizes the electrostatic latent image by adhering developer of each color component to the surface of photoconductor drum 413 to form a toner image.

For example, a direct-current developing bias of the same polarity as a charging polarity of charging device 414, or a developing bias with an alternating-current voltage superimposed by a direct-current voltage of the same polarity as the charging polarity of charging device 414 is applied to developing device 200. As a result, reversal development is performed in which the toner is adhered to the electrostatic latent image formed by exposing device 411.

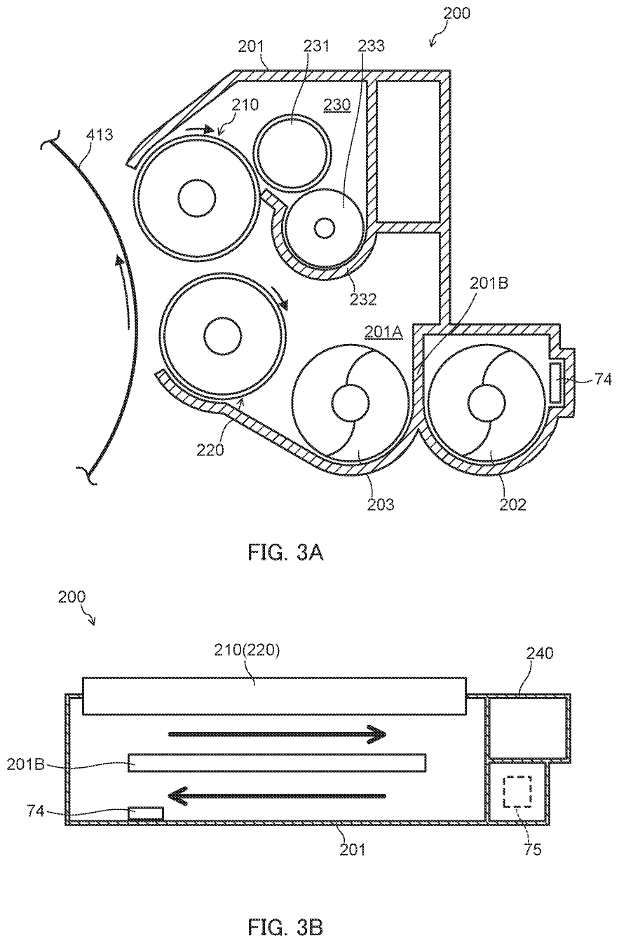

As illustrated in FIG. 3A, developing device 200 is configured with developer casing 201. Developer casing 201 includes housing section 201A in which the developer including the toner and a carrier is accommodated, collecting section 230, and developer discharging section 240 (see FIG. 3B). Moreover, within developer casing 201, first stirring member 202, second stirring member 203, first developing roller 210, second developing roller 220, developer detecting section 74, and toner refill section 75 (see FIG. 3B) are provided. First developing roller 210 and second developing roller 220 correspond to “developer bearing member” of the present invention.

As illustrated in FIGS. 3A and 3B, first stirring member 202 and second stirring member 203 are disposed respectively within regions partitioned by partitioning section 201B provided within developer casing 201. First stirring member 202 and second stirring member 203 correspond to “stirring member” of the present invention. It should be noted that, in the following description, each of first stirring member 202 and second stirring member 203 is simply referred to as “stirring member” when the members are not particularly distinguished.

First stirring member 202 and second stirring member 203 rotate so as to stir the developer within developer casing 201 and simultaneously convey the developer within developer casing 201 along flows of arrows around partitioning section 201B. In other words, first stirring member 202 and second stirring member 203 convey the developer longitudinally (in a side-to-side direction in FIG. 3B) within developer casing 201.

As illustrated in FIG. 3A, first developing roller 210 is disposed above second developing roller 220 so as to face photoconductor drum 413. First developing roller 210 receives the developer from second developing roller 220, and conveys the developer toward a first development nip that is a portion facing photoconductor drum 413. First developing roller 210 then supplies the toner to photoconductor drum 413 at the first development nip.

Second developing roller 220 faces photoconductor drum 413 on a more upstream side than the first development nip in a rotation direction of photoconductor drum 413. Second developing roller 220 conveys the developer within housing section 201A toward a second development nip that is a portion facing photoconductor drum 413. Second developing roller 220 supplies the toner to photoconductor drum 413 at the second development nip.

Collecting section 230 is provided above housing section 201A, and has collecting roller 231, collected developer housing section 232, and collecting/conveying member 233. Collecting section 230 collects the developer on first developing roller 210 with collecting roller 231 facing first developing roller 210, and returns the developer to housing section 201A via collected developer housing section 232.

As illustrated in FIG. 3B, developer discharging section 240 is a portion that discharges the developer within developer casing 201. Developer discharging section 240 is provided at a right end portion in an axial direction of developer casing 201, on a downstream side in a conveyance direction (upper arrow) of second stirring member 203.

Within developer discharging section 240, a screw member (not shown) rotates to cause a flow moving the developer from developer discharging section 240 into developer casing 201. The developer within developer casing 201 thereby does not get through developer discharging section 240.

When the toner is refilled within developer casing 201, with increase in an amount of the developer that tends to move from developer casing 201 toward developer discharging section 240, the developer moves from developer casing 201 to developer discharging section 240 to be discharged to a discharging section (not shown).

Moreover, if the developer amount within developer casing 201 is too much, for example, in such a condition that the developer amount is likely to increase, such as in a low temperature/low humidity environment, developer discharge control that forces the developer to be discharged via developer discharging section 240 is performed under the control of control section 101. The developer discharge control, for example, is performed by increasing a rotating speed of the stirring member. Moreover, if the developer amount within developer casing 201 is relatively low, for example, in such a condition that the developer amount is likely to decrease, such as in a high temperature/high humidity environment, control is performed such that the developer within developer casing 201 cannot easily move to developer discharging section 240, under the control of control section 101. This control, for example, is performed by reducing the rotating speed of the stirring member.

As illustrated in FIGS. 3A and 3B, developer detecting section 74 is portioned at a left end portion in the axial direction of developer casing 201. Developer detecting section 74 is disposed in a region where first stirring member 202 is located, in regions where first stirring member 202 and second stirring member 203 are located.

Developer detecting section 74 of magnetic permeability type is used for example, and detects a liquid level of the developer accommodated within developer casing 201 (see FIG. 3A) of developing device 200. Control section 101 adjusts the developer amount within developer casing 201 based on a result of the detection by developer detecting section 74. Developer amount adjustment control in control section 101 will be described later.

As illustrated in FIG. 3B, toner refill section 75 is portioned at the right end portion in the axial direction of developer casing 201, and refills the toner within developer casing 201. Control section 101 controls a toner refill amount in toner refill section 75 based on the detection result in developer detecting section 74. Control section 101 determines the toner refill amount so that a toner density within developer casing 201 reaches a predetermined density (for example, 6%).

First stirring member 202 conveys the developer in a direction from right to left in FIG. 3B. Consequently, when the toner has been refilled within developer casing 201 by toner refill section 75, developer detecting section 74 can detect the developer amount in a state where the developer has been sufficiently stirred by first stirring member 202.

As illustrated in FIG. 1, drum cleaning apparatus 415 has a flat-plate drum cleaning blade made of an elastic body in contact with the surface of photoconductor drum 413, and the like, and removes the toner remaining on the surface of photoconductor drum 413 without being transferred to intermediate transfer belt 421.

Intermediate transfer unit 42 includes intermediate transfer belt 421, primary transfer rollers 422, multiple support rollers 423, secondary transfer roller 424, belt cleaning apparatus 426, and the like.

Intermediate transfer belt 421 is composed of an endless belt, and stretched in a loop by multiple support rollers 423. At least one of multiple support rollers 423 is composed of a driving roller, and other support rollers are composed of driven rollers. For example, roller 423A disposed on a more downstream side in a belt running direction than primary transfer roller 422 for the K component is preferably the driving roller. A belt running speed in a primary transfer section may thereby easily be kept constant. As driving roller 423A rotates, intermediate transfer belt 421 runs at a constant speed in a direction of an arrow A.

Intermediate transfer belt 421 is a belt having conductivity and elasticity, and has a high-resistivity layer on its surface. Intermediate transfer belt 421 is rotationally driven by a control signal from control section 101.

Primary transfer rollers 422 are disposed on an inner peripheral surface side of intermediate transfer belt 421 so as to face photoconductor drums 413 of the respective color components. Primary transfer nips that transfer the toner images onto intermediate transfer belt 421 from photoconductor drums 413 are formed by pressing primary transfer rollers 422 against photoconductor drums 413 with intermediate transfer belt 421 sandwiched therebetween.

Secondary transfer roller 424 is disposed on an outer peripheral surface side of intermediate transfer belt 421 so as to face backup roller 423B disposed on the downstream side in the belt running direction of driving roller 423A. A secondary transfer nip that transfers the toner images onto the sheet S from intermediate transfer belt 421 is formed by pressing secondary transfer roller 424 against backup roller 423B with intermediate transfer belt 421 sandwiched therebetween.

When intermediate transfer belt 421 passes the primary transfer nips, the toner images on photoconductor drums 413 are sequentially superimposed and primarily transferred onto intermediate transfer belt 421. Specifically, by applying a primary transfer bias to primary transfer rollers 422 to give a charge with a polarity reverse to that of the toner to a back surface side of intermediate transfer belt 421, that is, a side which abuts primary transfer rollers 422, the toner images are electrostatically transferred onto intermediate transfer belt 421.

Then, when the sheet S passes the secondary transfer nip, the toner images on intermediate transfer belt 421 are secondarily transferred onto the sheet S. Specifically, by applying a secondary transfer bias to secondary transfer roller 424 to give a charge with a polarity reverse to that of the toner to a back surface side of the sheet S, that is, a side which abuts secondary transfer roller 424, the toner images are electrostatically transferred onto the sheet S. The sheet S having the toner images transferred thereon is conveyed toward fixing section 60.

Belt cleaning apparatus 426 removes transfer residual toner remaining on the surface of intermediate transfer belt 421 after the secondary transfer.

Fixing section 60 includes upper fixing section 60A having fixing surface side members disposed on a fixing surface of the sheet S, that is, on a surface side on which the toner images are formed; lower fixing section 60B having a back surface side support member disposed on a back surface of the sheet S, that is, on a surface side opposite to the fixing surface; a heating source, and the like. By pressing the back surface side support member against the fixing surface side members, a fixing nip that sandwiches and conveys the sheet S is formed.

In fixing section 60, the toner images are secondarily transferred, and the conveyed sheet S is heated and pressurized with the fixing nip, thereby fixing the toner images on the sheet S. Fixing section 60 is disposed as a unit within fixing device F

Upper fixing section 60A has endless fixing belt 61, heating roller 62, and fixing roller 63, which are the fixing surface side members. Fixing belt 61 is stretched by heating roller 62 and fixing roller 63.

Lower fixing section 60B has pressure roller 64, which is the back surface side support member. The fixing nip that sandwiches and conveys the sheet S is formed between pressure roller 64 and fixing belt 61.

Sheet conveying section 50 includes sheet feeding section 51, sheet ejecting section 52, and conveying path section 53. In three sheet feed tray units 51a to 51c constituting sheet feeding section 51, sheets S (standard sheets, special sheets) identified based on basis weight, size or the like are accommodated by each preset type. Conveying path section 53 has multiple conveyance roller pairs, including registration roller pair 53a. A registration roller section having registration roller pair 53a disposed therein corrects inclination and deflection of the sheets S.

The sheets S accommodated in sheet feed tray units 51a to 51c are delivered one by one from an uppermost portion and conveyed to image forming section 40 by conveying path section 53. In image forming section 40, the toner images on intermediate transfer belt 421 are secondarily transferred onto one surface of the sheet S collectively and subjected to a fixing process in fixing section 60. The sheet S on which the image has been formed is ejected to the outside of the apparatus by sheet ejecting section 52 including sheet ejection rollers 52a.

Next, the developer amount adjustment control will be described.

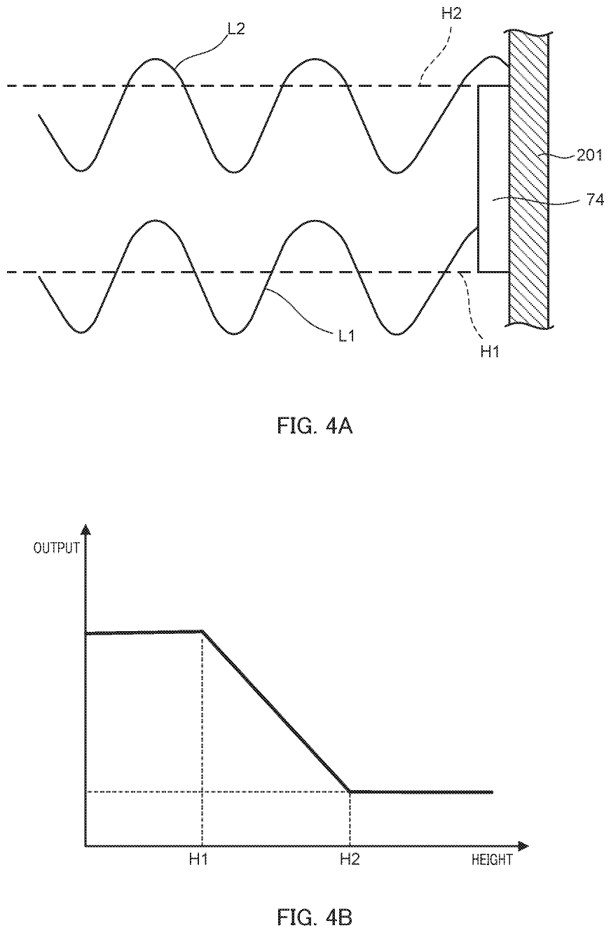

As illustrated in FIG. 3A, developer detecting section 74 is disposed at a predetermined height position within developer casing 201. For example, as illustrated in FIG. 4A, a range of the detection by developer detecting section 74 is assumed to be heights from H1 to H2. H1 is a lower limit height that is detectable by developer detecting section 74. H2 is an upper limit height that is detectable by developer detecting section 74.

As illustrated in FIG. 4B, an output value of developer detecting section 74 varies depending on the liquid level of the developer. Specifically, the output value of developer detecting section 74 within the detection range varies to be lower as the liquid level of the developer increases. In the case in which the detection range of developer detecting section 74 is the range from H1 to H2 as described above, the output value within the range from H1 to H2 varies to be lower as the liquid level of the developer increases.

The output value of developer detecting section 74 out of the detection range reaches a constant value regardless of the liquid level. Specifically, if the liquid level of the developer is higher than H2, the output value of developer detecting section 74 becomes the same as a case of the liquid level of H2 regardless of the liquid level. Moreover, if the liquid level of the developer is lower than H1, the output value of developer detecting section 74 becomes the same as a case of the liquid level of H1 regardless of the liquid level.

In this way, if a liquid level of the developer within developer casing 201 is within the detection range of developer detecting section 74, since the output value of developer detecting section 74 varies, change in the liquid level of the developer can be highly precisely detected. Inversely, if the liquid level of the developer within developer casing 201 is out of the detection range of developer detecting section 74, since the output value of developer detecting section 74 does not vary, the change in the liquid level of the developer becomes difficult to be detected.

Control section 101 adjusts the developer amount within developer casing 201 based on the output value (detection result) of developer detecting section 74. The developer amount has been set to an amount depending on each position within the detection range, and is caused to correspond to the output value of developer detecting section 74 depending on each position.

Moreover, within developer casing 201, since the developer is being stirred by the stirring member rotating at a predetermined rotating speed (for example, 475 rpm), the liquid level fluctuates as illustrated in FIG. 4A. Accordingly, the developer amount is set to a value in consideration of the liquid level associated with the fluctuation of the liquid level.

In an example illustrated in FIG. 4A, a liquid level L1 is located near H1 that is the lowest position within the detection range. Accordingly, in the present embodiment, the developer amount corresponding to the liquid level L1 is set as a minimum developer amount G1 that can be highly precisely detected by developer detecting section 74. It should be noted that the developer amount at the liquid level L1, for example, is 800 g.

A liquid level L2 is located near H2 that is the highest position within the detection range. Accordingly, in the present embodiment, the developer amount corresponding to the liquid level L2 is set as a maximum developer amount G2 that can be highly precisely detected by developer detecting section 74. It should be noted that the developer amount at the liquid level L2, for example, is 1000 g.

Control section 101 adjusts the developer amount within developer casing 201 to be within a developer amount range corresponding to the above described detection range, depending on the detection result in developer detecting section 74. In this way, the developer amount within developer casing 201 is appropriately controlled within the detection range, that is, within the range that can be highly precisely detected by developer detecting section 74.

Control section 101 sets the developer amount range based on the detection result in developer detecting section 74 to either a first detection condition where the developer amount range is a first range, or a second detection condition where the developer amount range is a second range.

The first range is a range that is set during a developing operation by the developing device, for example, a range from the developer amount G1 to the developer amount G2 as described above, that is, a range from 800 g to 1000 g.

Control section 101 first controls developing device 200 under the first detection condition when the developing operation is started in developing device 200. Control section 101 then performs a change from the first detection condition to the second detection condition based on the detection result in developer detecting section 74 under the first detection condition.

Specifically, control section 101 determines whether or not the developer amount based on the detection result in developer detecting section 74 under the first detection condition is larger than a predetermined threshold. A criterion may be arbitrarily set for determining whether or not the developer amount is larger than the predetermined threshold. The criterion, for example, may be whether or not the liquid level of the developer has reached H2. The predetermined threshold, for example, is a value that can be set as appropriate, such as an upper limit amount of the first range, and a value that is very close to the upper limit amount.

When it is determined by control section 101 that the developer amount is larger than the predetermined threshold, control section 101 performs the change from the first detection condition to the second detection condition.

When control section 101 performs the change from the first detection condition to the second detection condition, control section 101 controls the liquid level of the developer to be smaller than under the first detection condition. More particularly, When control section 101 performs the change from the first detection condition to the second detection condition, control section 101 reduces the rotating speed of the stirring member to be slower than the rotating speed in the case of the first detection condition (for example, 238 rpm).

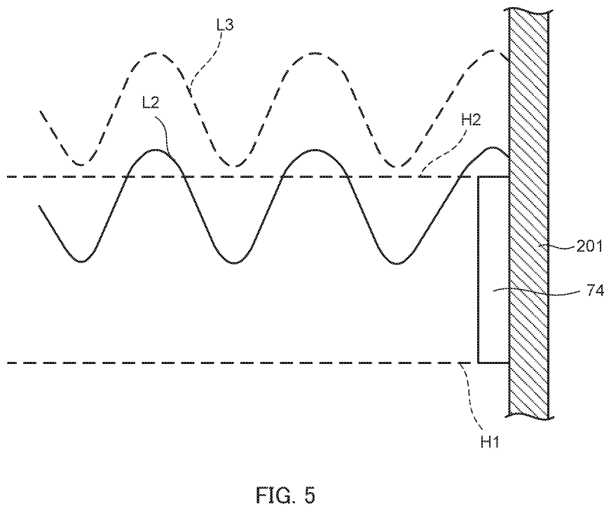

As described above, the developer amount is set to the value in consideration of the liquid level of the developer. As illustrated in FIG. 5, however, if the developer amount within developer casing 201 has exceeded the upper limit amount (see a liquid level L3 shown with a dashed line), a fluctuation state of the liquid level causes the developer amount to deviate from the detection range of developer detecting section 74. It should be noted that the developer amount at the liquid level L3, for example, is 1200 g.

Since the detection range of developer detecting section 74 is limited, the liquid level of the developer often deviates from the detection range of developer detecting section 74 in a case of a condition where variation of the developer increases. In particular, in a case of a configuration with the increase in the developer amount within developer casing 201 as developing device 200 is enlarged, the above described problem becomes significant.

Developer detecting section 74 cannot detect the liquid level of the developer out of the detection range of developer detecting section 74, and thus causes deteriorated detection precision for the developer amount.

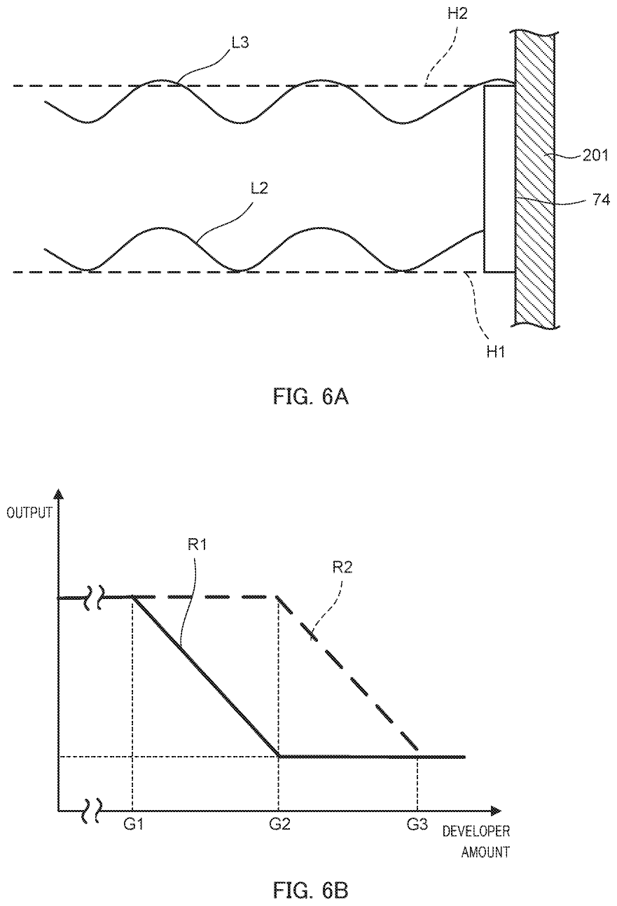

Accordingly, in the present embodiment, if the developer amount has exceeded the predetermined threshold, the developer amount range is changed to the second detection condition with the second range so as to reduce the rotating speed of the stirring member. As illustrated in FIG. 6A, amplitude of the fluctuation of the liquid level of the developer thereby becomes small, and thus the liquid level becomes low.

The second range is a range with an upper limit amount larger than that of the first range, and a lower limit amount larger than that of the first range, for example, a range of the developer amount from 1000 g to 1200 g.

In this way, since the liquid level L3 of the developer when the developer amount has exceeded the upper limit amount of the first range becomes low within the detection range of developer detecting section 74, developer detecting section 74 can detect the liquid level L3.

Consequently, as illustrated in FIG. 6B, the developer amount can be accurately detected by changing the range of the developer amount from a first range R1 under the first detection condition to a second range R2 under the second detection condition. This can facilitate appropriate comprehension of the developer amount within developer casing 201. It should be noted that FIG. 6B illustrates an example of the second range R2 with the lower limit amount set to G2 and the upper limit amount set to G3 larger than G2.

Control section 101 performs the detection under the second detection condition for a predetermined time (for example, 20 seconds), and determines whether or not the developer amount within developer casing 201 has exceeded an acceptable value, based on the developer amount under the second detection condition. The acceptable value is less than a maximum upper limit amount of the developer within developer casing 201, and, for example, may be set to an amount that prevents scatter of the developer from developer casing 201, such as the upper limit amount of the second range.

A criterion for determining whether or not the developer amount has exceeded the acceptable value, for example, may be whether or not the detection result in developer detecting section 74 under the second detection condition has reached a value corresponding to the acceptable value.

When it is determined by control section 101 that the developer amount has exceeded the acceptable value, control section 101 adjusts the developer amount within developer casing 201 to be decreased to be lower than the second range. Specifically, control section 101 adjusts the developer amount by adjusting a discharge amount in developer discharging section 240 to be increased.

In this way, even if the variation of the developer amount increases beyond the second range, the developer amount within developer casing 201 can be controlled to be within an appropriate range (the first range) by decreasing the developer amount.

Control section 101 also performs a change from the second detection condition to the first detection condition after completion of the adjustment of the developer amount. Also, When it is determined by control section 101 that the developer amount within developer casing 201 has not exceeded the acceptable value, control section 101 performs the change from the second detection condition to the first detection condition.

In this way, the developing operation is rapidly resumed after the completion of the adjustment of the developer amount, or if the developer amount is not excess.

The adjustment of the discharge amount in developer discharging section 240 may be performed at a timing when the detection by developer detecting section 74 under the second detection condition ends.

The discharge amount in developer discharging section 240, for example, is controlled with the rotating speed of the stirring member. In order to increase the discharge amount, for example, the rotating speed of the stirring member may be increased more than that in the developing operation so as to increase an amount of developer flowing into developer discharging section 240.

Control section 101, for example, causes transition from the first detection condition to the second detection condition at a timing of completion of a print job. In this way, if the developer amount has exceeded the upper limit amount of the first range in the detection result in developer detecting section 74, it is possible to determine whether or not the developer amount is large, soon after the completion of the print job.

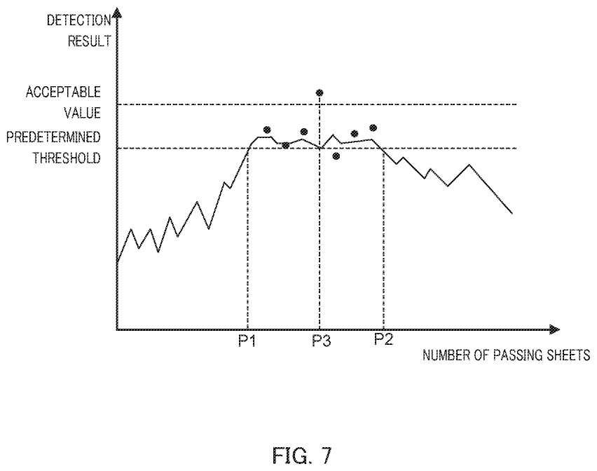

For example, if a print job for a certain number of sheets is repeated multiple times, as illustrated in FIG. 7, the detection result in developer detecting section 74 under the first detection condition is assumed to have exceeded the predetermined threshold in a range of a number of passing sheets from P1 to P2.

It should be noted that a vertical axis in FIG. 7 denotes the detection result in developer detecting section 74. A solid line in FIG. 7 denotes transition of the detection result in developer detecting section 74 under the first detection condition. Plots in FIG. 7 denote the detection results in developer detecting section 74 under the second detection condition.

In this case, control section 101 changes the detection condition in developer detecting section 74 to the second detection condition at each completion of the print job for the certain number of sheets, and performs the detection by developer detecting section 74. Thereby, if the detection result in developer detecting section 74, that is, the developer amount has exceeded the predetermined threshold, it is possible to rapidly determine whether or not the developer amount has reached the acceptable value.

It should be noted that, in an example illustrated in FIG. 7, since the developer amount exceeds the acceptable value when the number of passing sheets is P3, the developer amount is then adjusted.

Control section 101 starts the detection by developer detecting section 74 after a preparation time (for example, 10 seconds) has elapsed since the change from the first detection condition to the second detection condition. With the change in the liquid level of the developer, such as a change in the rotating speed of the stirring member, an accurate detection result may not be obtained due to a sudden variation of the liquid level or the like. The preparation time is thus inserted to thereby start the detection in developer detecting section 74 in a state where the liquid level of the developer is stabilized, so that the accurate detection result may be easily obtained.

Control section 101 performs the change from the second detection condition to the first detection condition after the detection of the developer amount under the second detection condition, or after the completion of the adjustment of the developer amount after the detection. Control section 101 then starts the detection by developer detecting section 74 after a recovery time (for example, 10 seconds) has elapsed since the change from the second detection condition to the first detection condition.

In this way, the recovery time is inserted before return to the first detection condition to thereby start the detection in developer detecting section 74 in the state where the liquid level of the developer is stabilized, so that the accurate detection result may be easily obtained.

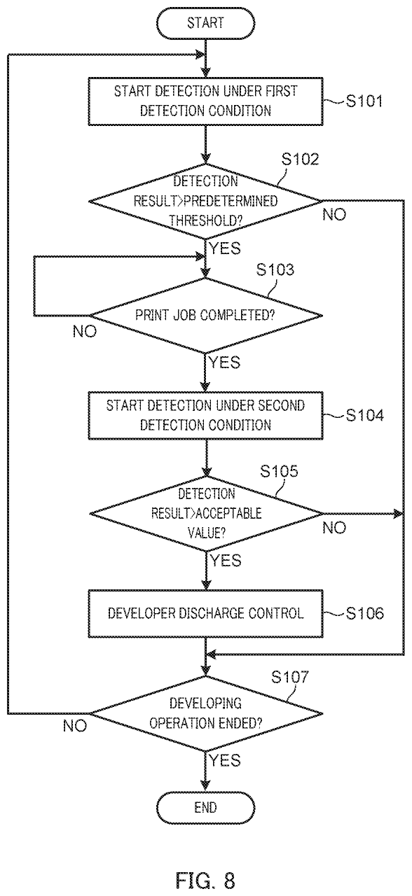

An operation example when the developer amount adjustment control is executed in image forming apparatus 1 will be described next. FIG. 8 is a flowchart illustrating an example of the operation example when the developer amount adjustment control is executed in image forming apparatus 1. A process in FIG. 8 is executed when control section 101 accepts a signal to perform the developing operation in developing device 200.

As illustrated in FIG. 8, control section 101 starts the detection under the first detection condition, with the developer amount range under the first detection condition (step S101). Control section 101 next determines whether or not the detection result in developer detecting section 74 is larger than the predetermined threshold (step S102).

As a result of the determination, if the detection result in developer detecting section 74 is equal to or less than the predetermined threshold (step S102, NO), the process transitions to step S107. In contrast, if the detection result in developer detecting section 74 is larger than the predetermined threshold (step S102, YES), control section 101 determines whether or not the print job has been completed (step S103). It should be noted that “print job” used herein denotes a print job involved when the process in step S102 has been performed, in print jobs included in the developing operation.

As a result of the determination, if the print job has not been completed (step S103, NO), the process in step S103 is repeated. In contrast, if the print job has been completed (step S103, YES), control section 101 transitions the developer amount range from the first detection condition to the second detection condition, and starts the detection under the second detection condition (step S104).

Control section 101 next determines whether or not the detection result in developer detecting section 74 is larger than the acceptable value (step S105). As a result of the determination, if the detection result in developer detecting section 74 is equal to or less than the acceptable value (step S105, NO), the process transitions to step S107.

In contrast, if the detection result in developer detecting section 74 is larger than the acceptable value (step S105, YES), control section 101 executes the developer discharge control (step S106). Control section 101 next determines whether or not the developing operation has ended (step S107).

As a result of the determination, if the developing operation has not ended (step S107, NO), the process returns to step S101. In contrast, if the developing operation has ended (step S107, YES), this control ends.

According to the present embodiment configured as above, it is determined whether or not the developer amount based on the detection result of the developer under the second detection condition has exceeded the acceptable value, which facilitates accurate determination of the developer amount within the developer casing. Consequently, overflow of the developer out of developer casing 201 can be inhibited. In other words, the developer amount within developer casing 201 can be appropriately controlled, and thus stabilization of the developer amount can be realized.

Since the developer amount range can be changed between the first detection condition and the second detection condition, single developer detecting section 74 can accurately detect the developer amount. Consequently, costs can be reduced in comparison with a configuration of providing multiple detecting sections.

In the present embodiment, since there is no individual difference caused in sensitivity of each detecting section as in the configuration of providing the multiple detecting sections, no variation occurs based on the individual difference, and the detection precision by developer detecting section 74 can thus be improved.

Since the liquid level of the developer can be differently set by differently setting the rotating speed of the stirring member, no complicated configuration is required, and the configuration can thus be simplified.

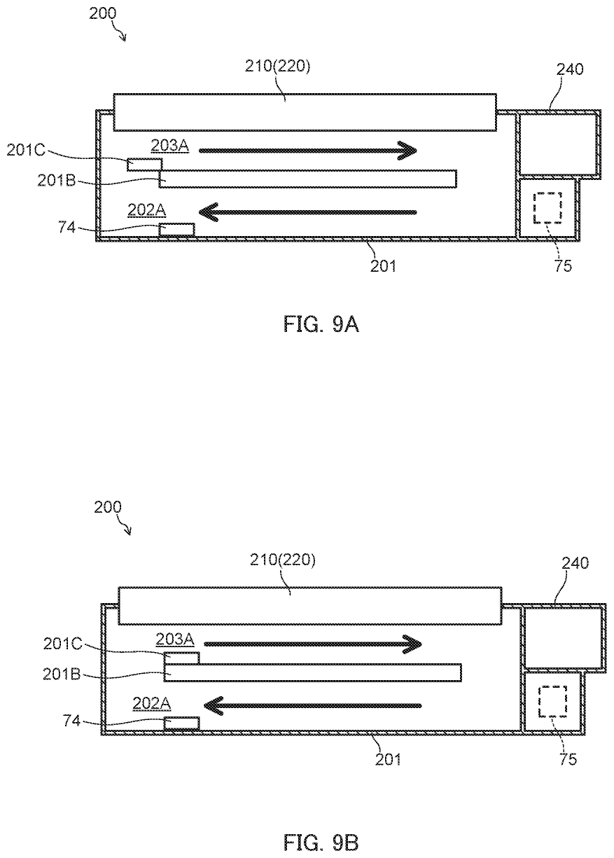

It should be noted that, in the above described embodiment, while the discharge amount of the developer is adjusted by adjusting the rotating speed of the stirring member, the present invention is not limited thereto. For example, as illustrated in FIGS. 9A and 9B, a configuration may be employed in which partitioning section 201B that is a partition between region 202A of first stirring member 202 and region 203A of second stirring member 203 includes adjustment section 201C that adjusts a width of a communication portion between region 202A and region 203A.

Region 203A communicates with developer discharging section 240 at a right end portion. Region 202B and region 203A communicate with each other on both left and right end sides of partitioning section 201B. Region 203A corresponds to “first circulator” of the present invention. Region 202A corresponds to “second circulator” of the present invention.

Adjustment section 201C is a plate-like member provided at a left end portion of partitioning section 201B, and is configured to be movable forward and backward with respect to the communication portion between region 202A and region 203A. Adjustment section 201C moves with an energized solenoid (not shown) from an advanced position (position in FIG. 9A) advancing from the communication portion, to a retreat position (position in FIG. 9B) retreating with respect to the communication portion.

In this way, an amount of the developer moving from region 202A to region 203A increases, which can increase the amount of the developer moving to developer discharging section 240, and can thus increase the discharge amount.

In this configuration, the adjustment of the width of the communication portion between region 202A and region 203A can also adjust a developer amount in region 202A and a developer amount in region 203A.

For example, in order to decrease the developer amount in region 202A, the width is set to a side of widening the width. This can reduce the liquid level of the developer near developer detecting section 74. Consequently, the liquid level of the developer enters the detection range of developer detecting section 74 to enable the detection of the liquid level of the developer by developer detecting section 74.

In this case, the developer amount in developer casing 201 can be an amount obtained by adding an amount of the developer that is estimated to have moved to a side of region 203A depending on the above described width, to the developer amount based on the detection result in developer detecting section 74. This enables the accurate detection of the developer amount within developer casing 201.

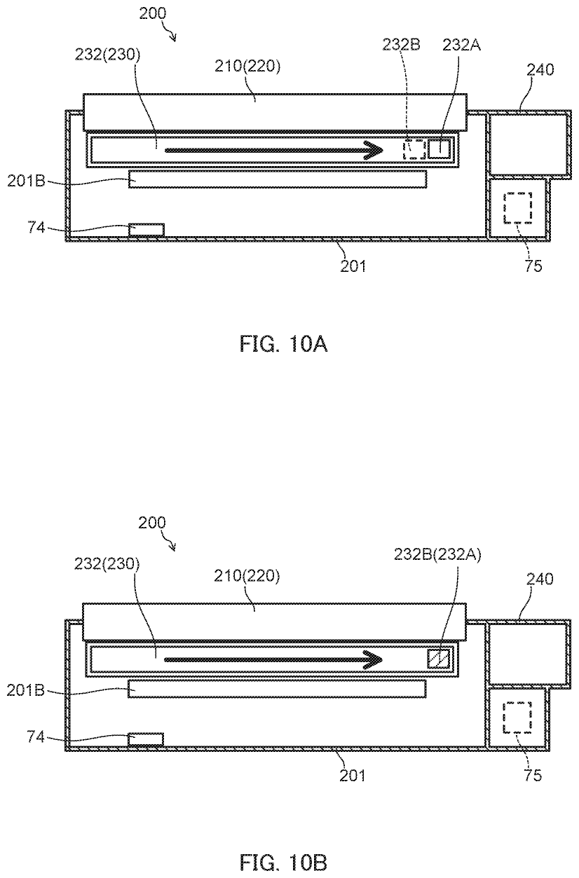

In the above described embodiment, different liquid levels of the developer are set for the first detection condition and the second detection condition by differently setting the rotating speed of the stirring member between the first detection condition and the second detection condition. The present invention, however, is not limited thereto. For example, as illustrated in FIGS. 10A and 10B, the different liquid levels of the developer may be set for the first detection condition and the second detection condition by adjusting an amount of the developer to be returned in collecting section 230.

Collecting section 230 has collecting roller 231, collected developer housing section 232, and collecting/conveying member 233, similarly to the above described embodiment (see also FIG. 3A). Collected developer housing section 232 is provided along first developing roller 210, and has a length in the axial direction that is approximately the same as that of first developing roller 210. Return port 232A is provided at a right end portion of collected developer housing section 232.

The developer collected by collecting roller 231 (not shown) is accommodated in collected developer housing section 232. The developer accommodated in collected developer housing section 232 is then conveyed by collecting/conveying member 233 (not shown) provided in collected developer housing section 232, in a direction from left to right so as to be returned to developer casing 201 via return port 232A.

Shutter 232B that can open and close return port 232A is provided at return port 232A of collected developer housing section 232. Shutter 232B puts return port 232A in an opened state (see FIG. 10A) into a closed state (see FIG. 10B) with an energized solenoid (not shown) or the like.

In this way, the developer can be kept in collecting section 230 by putting return port 232A into the closed state. The liquid level of the developer within developer casing 201 can be temporarily reduced by keeping the developer in collecting section 230 at the time of the change to the second detection condition.

Consequently, the developer amount within developer casing 201 can be accurately detected by setting an amount obtained by adding an amount of the developer kept in collecting section 230 to the detection result in developer detecting section 74, as the developer amount within developer casing 201.

In the above described embodiment, the change from the first detection condition to the second detection condition is performed at the timing of the completion of the print job after the developer amount has exceeded the predetermined threshold. The present invention, however, is not limited thereto. The change from the first detection condition to the second detection condition, for example, may be performed depending on a number of sheets to be printed after the developer amount has exceeded the predetermined threshold.

In this case, the number of sheets to be printed after the developer amount has exceeded the predetermined threshold is set to an appropriate number of sheets, for example, 3 kp, 6 kp or the like. In this way, productivity can be increased more than a case of this control performed at the timing of the completion of the print job. In contrast, as in the above described embodiment, if this control is performed at the timing of the completion of the print job, the developer amount is determined for each print job, which thus can increase stability of the developer amount.

In the above described embodiment, the change from the first detection condition to the second detection condition is performed based on the detection result in developer detecting section 74 under the first detection condition. The present invention, however, is not limited thereto. For example, regardless of the above described detection result, the setting of the developer amount range may be changed from the first detection condition to the second detection condition at a certain interval. In other words, control section 101 may perform the change from the first detection condition to the second detection condition based on the number of sheets to be printed under the first detection condition.

The number of sheets to be printed in this case may be a number of sheets that is arbitrarily defined by the user, for example, 60 kp or the like. In this way, the productivity can be increased since frequency of the change can be reduced more than a case of the change of the detection condition based on the detection result in developer detecting section 74 under the first detection condition.

Control section 101 may change the number of sheets to be printed that is a criterion for the change from the first detection condition to the second detection condition, depending on the toner density of the developer within developer casing 201.

For example, if the toner density becomes relatively low, such as a density equal to or less than 6%, the number of sheets to be printed is reduced to 12 kp or the like, which is lower than a case of a toner density more than 6%.

Since the developer amount relatively increases as the toner density becomes relatively low, in such a case, the developer amount can easily be set to an appropriate amount by increasing frequency of performing this control.

Control section 101 may change the number of sheets to be printed that is the criterion for the change from the first detection condition to the second detection condition, depending on environment conditions around developing device 200.

For example, during a day, if temperature and humidity conditions when use of developing device 200 is started are low temperature and low humidity conditions, the same temperature and humidity conditions are considered to remain during the day. Since the low temperature and low humidity conditions are conditions where the developer amount is likely to increase, in such a case, the number of sheets to be printed is reduced to 6 kp or the like, which is lower than a case of other environment conditions.

The frequency of performing this control can thereby be increased in the case of the low temperature and low humidity conditions, so that the developer amount can easily be set to the appropriate amount.

In the above description, the detection result in developer detecting section 74 under the first detection condition, or the number of sheets to be printed under the first detection condition has been illustrated as a predetermined condition in operations under the first detection condition. The present invention, however, is not limited thereto. The predetermined condition, for example, may be a sliding distance of a developing roller under the first detection condition. The predetermined condition may also be more than one of the detection result in developer detecting section 74 under the first detection condition, the number of sheets to be printed under the first detection condition, and the sliding distance of the developing roller under the first detection condition, or may be other conditions.

In the above described embodiment, while developer detecting section 74 is provided at the left end portion of developer casing 201, the present invention is not limited thereto, and developer detecting section 74 may be provided at any position of developer casing 201.

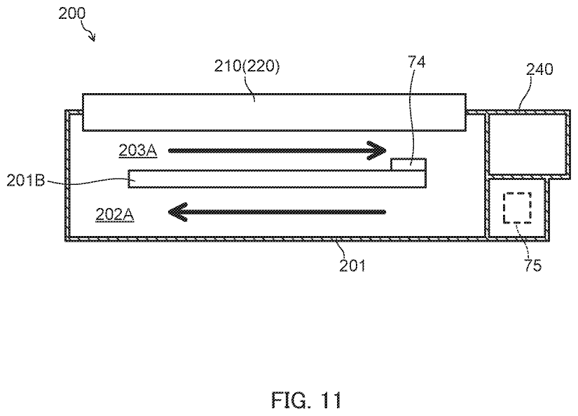

As illustrated in FIG. 11, for example, developer detecting section 74 may be provided at the right end portion of partitioning section 201B in developer casing 201. More particularly, developer detecting section 74 may be provided at a downstream end of region 203A.

The downstream end of region 203A is a downstream end of region 203A in a direction in which the developer flows (the direction from left to right). Developer discharging section 240 and region 203A communicate with each other at the downstream end.

In this way, since the liquid level of the developer through the discharge by developer discharging section 240 is easily detected by developer detecting section 74, the user may easily comprehend discharge performance in developer discharging section 240.

In the above described embodiment, the preparation time and the recovery time are provided when the setting of the developer amount range is changed between the first detection condition and the second detection condition. The present invention, however, is not limited thereto, and the preparation time and the recovery time may not be provided. The preparation time and the recovery time may also be arbitrarily changed.

A detection time of the developer amount under the second detection condition, and a developer discharge time in developer discharging section 240 associated with the adjustment of the developer amount may be set to any time. The present invention, however, is not limited thereto, and the user may be enabled to change these times as appropriate. Also, while a developer discharge timing has been a case where the acceptable value has been exceeded, the present invention is not limited thereto, and the user may be enabled to change the timing as appropriate.

For example, a configuration may be employed in which the user can select from patterns with different detection times of the developer amount and different developer discharge times, or patterns with different detection timings of the developer amount and different developer discharge timings, respectively.

In order to improve the detection precision for the developer amount, the detection time of the developer amount needs to be set to a relatively long time. Moreover, in order to improve adjustment precision for the developer amount, the developer discharge time needs to be set to a relatively long time.

In contrast, the above described respective times that are long have an effect on the productivity. Accordingly, the user's needs can be addressed by enabling the user to select any of multiple patterns.

For example, three patterns including a first pattern, a second pattern, and a third pattern are assumed to be selectable.

The first pattern is a pattern in initial settings, and is a pattern in which the detection time of the developer amount, for example, is set to 15 seconds, and the developer discharge time, for example, is set to 15 seconds.

The second pattern is a pattern with the different detection timing of the developer amount and the different developer discharge timing, respectively. In the second pattern, for example, if the developer amount has exceeded the predetermined threshold under the first detection condition for the first time, the change to the second detection condition is performed, and only the detection of the developer amount is performed without the discharge of the developer. The detection time of the developer in this case is set to a longer time than in the first pattern (for example, 30 seconds).

In the second pattern, if the developer amount has exceeded the predetermined threshold next under the first detection condition, only the discharge of the developer is performed without the detection of the developer amount under the second detection condition. The developer discharge time in this case is set to a longer time than in the first pattern (for example, 30 seconds).

In this way, in the second pattern, either one of the detection of the developer amount and the discharge of the developer is performed in a total time of the detection time of the developer amount and the developer discharge time in the first pattern, which provides the productivity equivalent to the first pattern. While this prevents immediate performance of the adjustment of the developer amount, this can improve the detection precision for the developer amount with the productivity similar to the first pattern.

The third pattern is a pattern in which the detection time of the developer amount and the developer discharge time are set to longer times than in the first pattern (for example, 30 seconds, respectively).

In this way, while the productivity is reduced more than in the first pattern and the second pattern, both the detection time of the developer amount and the developer discharge time are lengthened, which thus can improve the detection precision for the developer and the adjustment precision for the developer.

The user's needs can be addressed by selecting from these patterns by the user. It should be noted that, in the above description, various patterns may be enabled to be set without limitation to the above described patterns.

In the above described embodiment, while the developer amount is adjusted if the developer amount is determined to have exceeded the acceptable value, the present invention is not limited thereto. For example, When it is determined by control section 101 that the developer amount has exceeded the acceptable value, control section 101 may perform control to inform the user thereof.

The control to inform the user includes controlling display section 21 to display the information, and causing sound.

In this way, the user can comprehend that the developer amount is not normal.

In the above described embodiment, the upper limit amount of the second range is larger than the upper limit amount of the first range, and the lower limit amount of the second range is larger than the lower limit amount of the first range. The present invention, however, is not limited thereto. For example, the upper limit amount of the second range may be less than the upper limit amount of the first range, and the lower limit amount of the second range may be less than the lower limit amount of the first range.

In this case, the acceptable value, for example, is an amount when the developer amount within developer casing 201 has decreased without limit. Exceeding the acceptable value in this case refers to the fact that the developer amount falls below the acceptable value.

Also in this case, When it is determined by control section 101 that the developer amount has exceeded the acceptable value, control section 101 increases the liquid level of the developer higher than under the first detection condition. Specifically, control section 101 performs control in a manner opposite to the above described embodiment, such as increasing the rotating speed of the stirring member more than under the first detection condition. Moreover, the adjustment of the developer amount includes reducing the discharge amount in developer discharging section 240, and increasing the toner refill amount by toner refill section 75.

In this way, it is possible to inhibit generation of unevenness on the image caused by the stirring member due to too much decrease in the developer amount within developer casing 201.

In the above described embodiment, while the detection range in developer detecting section 74 is fixed in the range of the heights from H1 to H2, the present invention is not limited thereto. Developer detecting section 74, for example, may be configured to be movable upward and downward. Accordingly, the position of the liquid level of the developer can be accurately detected by differently setting the height position of developer detecting section 74 to move its detection range. Developer detecting section 74 may also be configured to have an orientation that is changeable in an obliquely upward direction or an obliquely downward direction. Accordingly, the position of the liquid level of the developer can be accurately detected by changing the orientation of developer detecting section 74 to differently set its detection range. The developer amount range can also be changed in this way.

As for the rest, the above described embodiment merely illustrates an example of embodiment for practicing the present invention, and the technical scope of the present invention shall not be construed to be limited thereto. In other words, the present invention can be practiced in various forms without deviating from the gist or essential characteristics of the present invention.

Although embodiments of the present invention have been described and illustrated in detail, the disclosed embodiments are made for purposes of illustration and example only and not limitation. The scope of the present invention should be interpreted by terms of the appended claims.

What is claimed is:

1. A developing device, comprising:
a developer casing that accommodates developer to be supplied to a developer bearing member;
a developer detector that detects a liquid level of the developer within the developer casing; and
a hardware processor that performs control to set a developer amount range based on a detection result in the developer detector to either a first detection condition where the developer amount range is a first range that is a range during a developing operation, or a second detection condition where the developer amount range is a second range that is different from the first range,
wherein the hardware processor determines whether or not a developer amount within the developer casing has exceeded an acceptable value, based on the detection result in the developer detector under the second detection condition.

2. The developing device according to claim 1, wherein
the hardware processor sets different liquid levels of the developer, respectively, for the first detection condition and the second detection condition.

3. The developing device according to claim 2, comprising:
a stirring member that rotates within the developer casing to stir the developer,
wherein the hardware processor sets different rotating speeds of the stirring member, respectively, for the first detection condition and the second detection condition.

4. The developing device according to claim 2, comprising:
a collector that collects the developer from the developer bearing member and returns the developer to the developer casing,
wherein the hardware processor sets different amounts of the developer to be returned in the collector, respectively, for the first detection condition and the second detection condition.

5. The developing device according to claim 2, wherein
the developer casing has a first circulator, a second circulator in communication with the first circulator, and an adjuster that adjusts a width of a communication portion between the first circulator and the second circulator, and
wherein the hardware processor sets different amounts of the width with the adjuster, respectively, for the first detection condition and the second detection condition.

6. The developing device according to claim 1, wherein
the hardware processor performs a change from the first detection condition to the second detection condition based on a predetermined condition during the operation under the first detection condition.

7. The developing device according to claim 6, wherein
the hardware processor performs the change from the first detection condition to the second detection condition based on at least one of the following: the detection result in the developer detector under the first detection condition; a number of sheets to be printed under the first detection condition; and a sliding distance of the developer bearing member under the first detection condition.

8. The developing device according to claim 7, wherein
when the hardware processor performs the change from the first detection condition to the second detection condition based on the detection result in the developer detector under the first detection condition, the hardware processor performs the change from the first detection condition to the second detection condition at a timing of completion of a print job.

9. The developing device according to claim 7, wherein
when the hardware processor performs the change from the first detection condition to the second detection condition based on the detection result in the developer detector under the first detection condition, the hardware processor performs the change from the first detection condition to the second detection condition based on the number of sheets to be printed after the developer amount has exceeded a predetermined threshold.

10. The developing device according to claim 7, wherein
when the hardware processor performs the change from the first detection condition to the second detection condition based on the number of sheets to be printed under the first detection condition, the hardware processor changes the number of sheets to be printed that is a criterion for the change from the first detection condition to the second detection condition, depending on a toner density of the developer within the developer casing.

11. The developing device according to claim 7, wherein
when the hardware processor performs the change from the first detection condition to the second detection condition based on the number of sheets to be printed under the first detection condition, the hardware processor changes the number of sheets to be printed that is a criterion for the change from the first detection condition to the second detection condition, depending on an environment condition around the developing device.

12. The developing device according to claim 1, wherein
the hardware processor performs:
starting the detection by the developer detector after a preparation time elapses since the change from the first detection condition to the second detection condition; and
starting the detection by the developer detector after a recovery time elapses since a change from the second detection condition to the first detection condition.

13. The developing device according to claim 1, wherein
when determining by the hardware processor that the developer has exceeded the acceptable value, the hardware processor adjusts the developer amount within the developer casing.

14. The developing device according to claim 13, comprising:
a developer discharger that discharges the developer from the developer casing,
wherein the hardware processor adjusts the developer amount by adjusting a discharge amount of the developer in the developer discharger.

15. The developing device according to claim 14, comprising:
a stirring member that rotates within the developer casing to stir the developer,
wherein the hardware processor adjusts the discharge amount of the developer by adjusting a rotating speed of the stirring member.

16. The developing device according to claim 14, wherein
the developer casing has a first circulator, a second circulator in communication with the first circulator, and an adjuster that adjusts a width of a communication portion between the first circulator and the second circulator, and
wherein the hardware processor adjusts the discharge amount of the developer by adjusting the width of the adjuster.

17. The developing device according to claim 1, wherein
when determining by the hardware processor that the developer has exceeded the acceptable value, the hardware processor performs control to inform a user, accordingly.

18. The developing device according to claim 1, comprising:
a developer discharger that discharges the developer from the developer casing,
wherein the developer casing has a first circulator, and a second circulator in communication with the first circulator,
wherein the developer discharger communicates with the first circulator at a downstream end of the first circulator in a direction in which the developer flows, and
wherein the developer detector is provided at the downstream end of the first circulator.

19. An image forming apparatus, comprising:
a developer casing that accommodates developer to be supplied to a developer bearing member;
a developer detector that detects a liquid level of the developer within the developer casing; and
a hardware processor that performs control to set a developer amount range based on a detection result in the developer detector to either a first detection condition where the developer amount range is a first range that is a range during a developing operation, or a second detection condition where the developer amount range is a second range that is different from the first range,
wherein the hardware processor determines whether or not a developer amount within the developer casing has exceeded an acceptable value, based on the detection result in the developer detector under the second detection condition.
